(19) United States
(12) Patent Application Publication
(10) Pub. No.: US 2021/0107612 A1
(43) Pub. Date: Apr. 15, 2021

(54) Articulating Robotic Manipulator (ARM) for Underwater Wood Harvesting

(71) Applicant: Lonnie Hayward, Abbotsford (CA)

(72) Inventor: Lonnie Hayward, Abbotsford (CA)

(21) Appl. No.: 17/070,903

(22) Filed: Oct. 14, 2020

Related U.S. Application Data
(60) Provisional application No. 62/914,642, filed on Oct. 14, 2019.

(51) Int. Cl. B63C 11/52; B25J 11/00; B25J 5/06; B25J 19/02; B25J 19/00

(52) U.S. Cl. CPC B63C 11/52; B25J 11/0055; B25J 19/0025; B25J 19/026; B25J 5/06

(57) ABSTRACT

An articulating robotic manipulator for underwater wood harvesting having a mechanical articulating arm that folds onto of itself and sits on a floating barge used for cutting under water trees that have been flooded. The ARM is controlled by an operator who is placed in a cabin on the barge above. The barge is a horseshoe cape and the folding arm deploys down the center of the barge and into the water. The barge contains side thrusters and trees can be seen under water using side scan sonar units. The arm consists of five booms and three cylinders. The ARM is 120-feet with a single ballast/tank. It can drop down and swivel 180-degrees. The ARM includes an air delivery system enclosed in the arm from the barge to the cutting head. The cutting head uses a custom cutting head that can open to 10-feet wide. The barge comprises eight ballasts.

### TECHNICAL FIELD OF THE INVENTION

The present invention relates generally to the field of devices for manipulating objects under water. More specifically, the present invention relates to the field of devices for manipulating objects under water and in particular to booms for extending underwater from the water surface where the underwater end of the boom has a manipulating device mounted thereto, such as a means for gripping objects, for manipulating objects by selectively actuable articulation of the boom and manipulating device.

### BACKGROUND OF THE INVENTION

Flooding of forested valleys by reason of natural causes or by reason of hydroelectric damming has left submerged forest as unharvested free-standing trees. A substantial percentage of the submerged free-standing trees are within depths of approximately 100 feet of water and so are available to be harvested given an appropriate log cutting and retrieval mechanism.

As opposed to well understood dry land logging practices, the harvesting of submerged free-standing trees presents many obstacles. Such obstacles include the fact that if manual divers are used to dive to the base of such trees, to either cut through the tree trunks using saws or other means such as blasting to uproot or free the tree, the diver is faced with severe restrictions on the amount of time that may be spent at such depths.

Further, the difficulty of wielding saws or the like in an underwater environment can prove dangerous to the diver. Because a majority of the submerged free-standing trees are waterlogged, they will not rise to the surface of their own accord once uprooted or otherwise freed from the bottom and so must be retrieved by means of cables, flotation bags or the like. The result is a slow process which does not yield many logs harvested in a typical day.

In the case of some of the larger submerged free-standing trees, they are so large, because they form part of very old stands of timber, that unassisted manual sawing is very difficult and retrieval slow and difficult.

A further obstacle relates to underwater visibility. It is known in the prior art to attempt underwater cutting or sawing of submerged elongate objects such as logs or pilings, but what is not addressed is the fact that activity at or near the mudline results in stirring up of silt or the like which quickly makes seeing underwater difficult if not impossible. Such difficulties are in addition to the normal darkness one would anticipate at depth.

However, the solution to the problem is not merely the use of underwater lighting. By way of analogy, the problem is akin to the use of driving headlights when set on high beam in a snowstorm. The result is merely a whiteout. Thus, because it is desired to saw or cut submerged free-standing trees near their base so as to maximize the recovery of the timber, a means must be provided for clearing, or seeing through, the murky water if is it desired to use a remotely actuated mechanical device employing a real time imaging system for positioning the gripping and sawing or cutting means.

### SUMMARY OF THE INVENTION

An Articulating Robotic Manipulator for Underwater Wood Harvesting (ARM) which comprises a mechanical articulating arm that folds onto of itself and sits on a floating barge. The present invention is used for cutting under water trees that have been flooded.

The ‘ARM is controlled by an operator who is placed in a cabin on the barge above. The barge is a horseshoe cape and the folding arm deploys down the center of the barge and into the water. The barge contains side thrusters and trees can be seen under water using side scan sonar units.

The ARM is 120-feet with a single ballast/tank. It can drop down and swivel 180-degrees. Additionally, the ARM includes an air delivery system enclosed in the arm from the barge to the cutting head. The cutting head uses a custom cutting head that can open to 10-feet wide.

The barge comprises eight ballasts. The barge also contains side thrusters and uses sonar to improve visibility underwater. The barge has a SR90 being run on its own Barge-system and is motorized separately.

The present invention uses two separate motors: one to run the hydraulic and produce electrical. The other to propel the barge.

At the end of the folding arm, there is a cutting and grasping head. There are other head units that can dredge, grapple and rake. The interchangeable utility heads may include, but are not limited to the following types of heads: selectively operable claws; a selectively operable clam shell rake; a selectively operable overpack; a selectively operable suction dredge; a selectively articulatable viewing arm; a selectively operable core sampling head; an extraction head; a selectively operable vibrator head; a selectively operable grout application head; and, a selectively operable surface cleaning head.

### BRIEF DESCRIPTION OF THE DRAWINGS

The accompanying drawings, which are incorporated herein and form a part of the specification, illustrate the present invention and, together with the description, further serve to explain the principles of the invention and to enable a person skilled in the pertinent art to make and use the invention.

FIG. 1 is an illustration of the Articulating Robotic Manipulator (ARM) for Underwater Wood Harvesting as taught by the present invention.

FIG. 2 is a detailed illustration of Joint 1 as taught and used by the present invention.

FIG. 3 is a detailed illustration of Joints 2 and 3 as taught and used by the present invention.

FIG. 4 is a detailed illustration of Joint 2 as taught and used by the present invention.

FIG. 5 is a detailed illustration of Joint 3 as taught and used by the present invention.

FIG. 6 is a detailed illustration of Joints 4 and 5 as taught and used by the present invention.

FIG. 7 is a detailed illustration of Joint 4 as taught and used by the present invention.

FIG. 8 is a detailed illustration of Joint 5 as taught and used by the present invention.

FIG. 9 illustrates the pillow block as taught and used by the present invention.

FIGS. 10-11 illustrate the manually controlled deployment procedure and home position of the motion of the ARM.

FIGS. 12-15 illustrate the intermediate positions of the computer controlled motion of the ARM.

### DETAILED DESCRIPTION OF THE INVENTION

In the following detailed description of the invention of exemplary embodiments of the invention, reference is made to the accompanying drawings (where like numbers represent like elements), which form a part hereof, and in which is shown by way of illustration specific exemplary embodiments in which the invention may be practiced.

These embodiments are described in sufficient detail to enable those skilled in the art to practice the invention, but other embodiments may be utilized and logical, mechanical, electrical, and other changes may be made without departing from the scope of the present invention. The following detailed description is, therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, well-known structures and techniques known to one of ordinary skill in the art have not been shown in detail in order not to obscure the invention.

The present invention, herein referred to as an Articulating Robotic Manipulator for Underwater Wood Harvesting or “ARM”, comprises a mechanical articulating arm that folds onto of itself and sits on a floating barge. The present invention is used for cutting under water trees that have been flooded.

At the end of the folding arm, there is a cutting and grasping head. There are other head units that can dredge, grapple and rake. The interchangeable utility heads may include, but are not limited to the following types of heads: selectively operable claws; a selectively operable clam shell rake; a selectively operable overpack; a selectively operable suction dredge; a selectively articulatable viewing arm; a selectively operable core sampling head; an extraction head; a selectively operable vibrator head; a selectively operable grout application head; and, a selectively operable surface cleaning head.

The ‘ARM is controlled by an operator who is placed in a cabin on the barge above. The barge is a horseshoe cape and the folding arm deploys down the center of the barge and into the water. The barge contains side thrusters and trees can be seen under water using side scan sonar units. The present invention has a weight capacity of 5 tons.

In one embodiment, the ARM is 120-feet with a single ballast/tank. It can drop down and swivel 180-degrees. Additionally, the ARM includes an air delivery system enclosed in the arm from the barge to the cutting head. The cutting head uses a custom cutting head that can open to 10-feet wide.

The barge comprises eight ballasts. The barge also contains side thrusters and uses sonar to improve visibility underwater. The barge has a SR90 being run on its own Barge-system and is motorized separately.

The present invention uses two separate motors: one to run the hydraulic and produce electrical. The other to propel the barge.

The system of the present invention is designed to use a HITACHI system and 4-cylinder diesel which are all given direction via a LINUX related program or ran manually.

In an alternative embodiment, the present invention was a 60 ft ARM with two tank system on the far end of the arm which has now become a 120 ft arm with a single ballast or tank. In an alternative embodiment, the arm was originally a drop down arm that hinged to the center of the deck. but in an improved embodiment, the arm drops down and can swivel 180 degrees.

The original embodiment of the ARM used a water system to bring water down to the cutting area to improve visibility where the improved embodiment uses sonar to assist the operator with visibility.

The original embodiment of the ARM used a VW diesel hydraulic system which ran all systems with this where the improved embodiment was designed to use a HITACHI system and 4 cylinder diesel

The original embodiment of the ARM used a MICROSOFT software which was incorporated into the hydraulic. An alternative, improved embodiment can either be run manually or with a new LINUS related program.

With the original embodiment of the ARM, the Barge contained six ballast tanks and the new one contains eight ballast tanks.

The original embodiment of the ARM had an external air delivery system for the tanks and the new one has the air system enclosed in the arm from barge to cutting head.

Each hinge on the new embodiment of the ARM uses (JOHN DEERE/HITACHI) patented pin hinges.

The changes resulting from the initial ARM to the alternative and improved version of the arm, after extensive research, development, testing, and experimentation, has resulting in the weight capacity has changed from 2.5 tones to double, 5 tones.

The original embodiment of the ARM was designed for a generic cutting head and an alternative, improved embodiment can use a custom cutting head that can open to 10 feet wide.

The original embodiment of the ARM used the diesel motor for both propelling and hydraulics. An alternative, improved embodiment has two separate motors, one motor to run the hydraulics and produce electrical and the other motor to propel the barge.

The original embodiment of the ARM the SR90, which sat on the main barge. an alternative, improved embodiment has the SR90 being run on its own barge system and motorize separately.

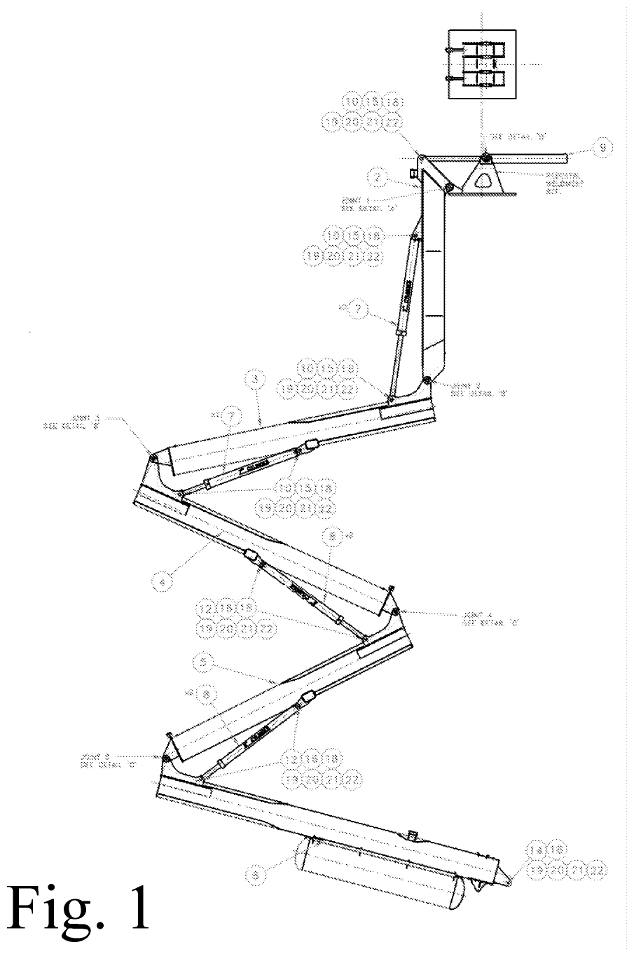

Now referring to the Figures, the Articulating Robotic Manipulator (ARM) for Underwater Wood Harvesting as taught by the present invention is illustrated. FIG. 1 is an illustration of the ARM and its component parts of the assembly. The arm 1 consists of five booms 2, 3, 4, 5, and 6; three cylinders 7, 8, 9, a cylinder trunnion 9, five pins 10, 11, 12, 13, 14, three bushings 15, 16, 17, a pin keeper 18, a spacer 19, capscrew 20, flat washer 21, grease fitting 22, encoder mounting bracket 25, capscrew 26, nut 27, jam nut 28, capscrew 29, lock washer 30, set screw 31, pillow block 32, capscrew 34 and flat washer 35.

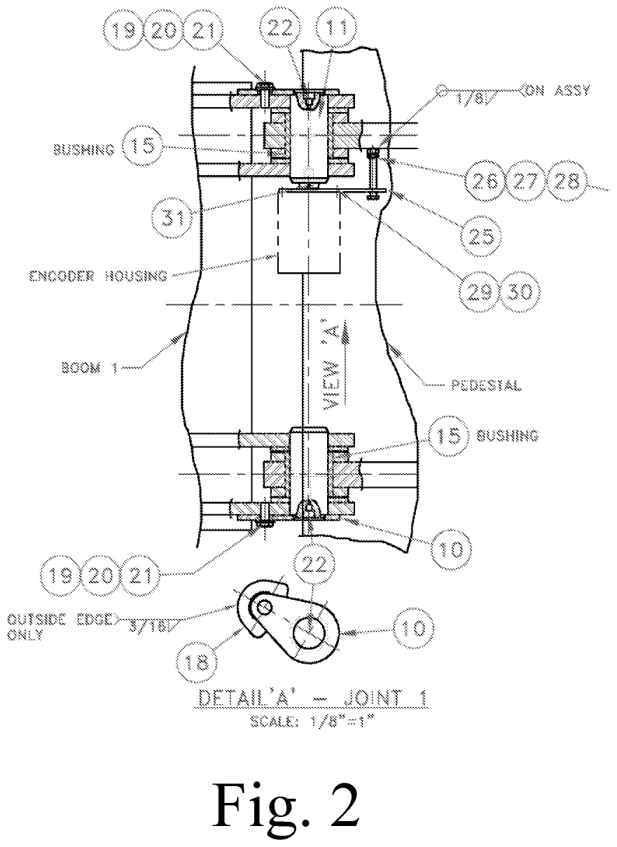

FIG. 2 is a detailed illustration of Joint 1. The first boom 2 (Boom 1) is connected by to a first cylinder 9 on one end by using a pin 10, bushing 15, pin keeper 18, spacer 19, capscrew 20, flat washer 21, and a grease fitting 22.

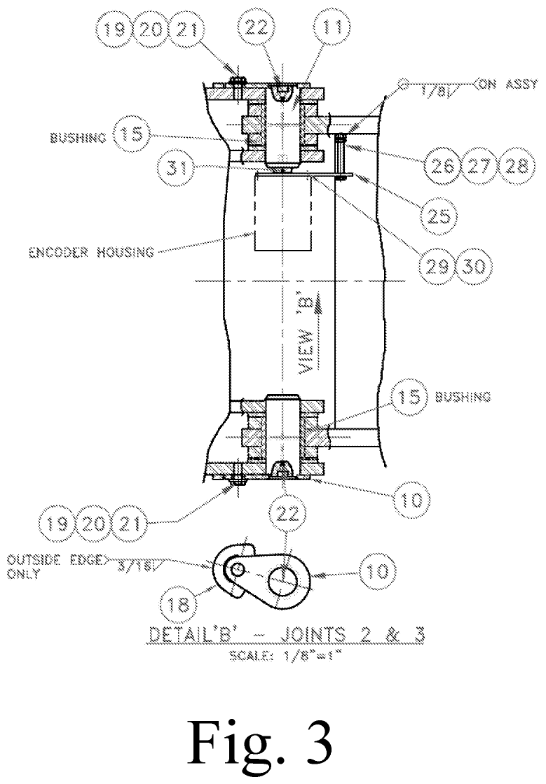

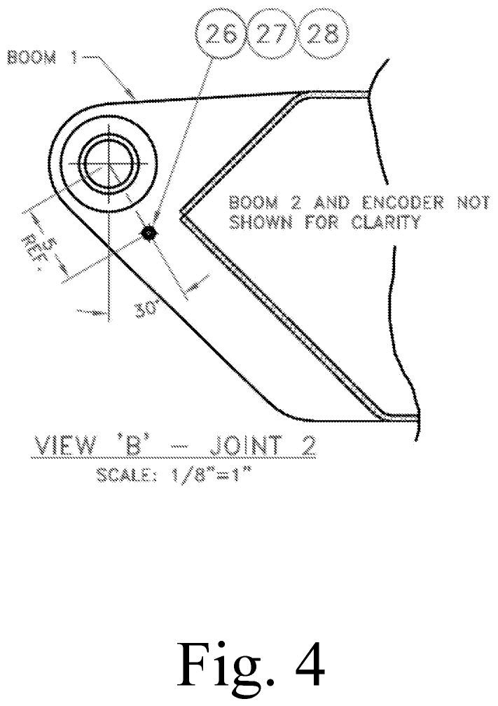

Now referring to FIGS. 3 and 4 illustrating Joint 2, on an opposing end of the first boom 2, the first boom 2 is connected to a second boom 3 using a capscrew 26, nut 27, jam nut 28. A first cylindered 7 is connect between the first boom 2 and the second boom 3 to provide articulation by using a pin 10, bushing 15, pin keeper 18, spacer 19, capscrew 20, flat washer 21, and a grease fitting 22 on each end to secure the first cylinder 7 to the first boom 2 and second boom 3.

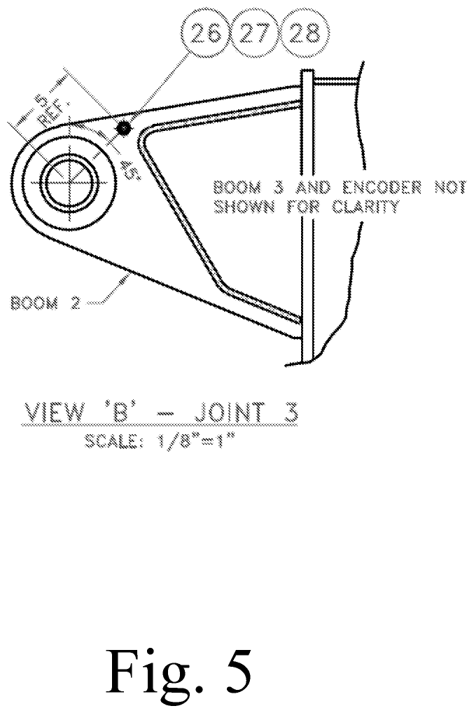

Now referring to FIGS. 3 and 5 illustrating Joint 3, on an opposing end of the second boom 3 a capscrew 26, nut 27, jam nut 28 attaches a third boom 4 to the second boom 3. A second cylinder 7 is connected between the second boom 3 and the third boom 4 to provide articulation by using a pin 10, bushing 15, pin keeper 18, spacer 19, capscrew 20, flat washer 21, and a grease fitting 22 on each end to secure the second cylinder 7 to the second boom 3 and third boom 4.

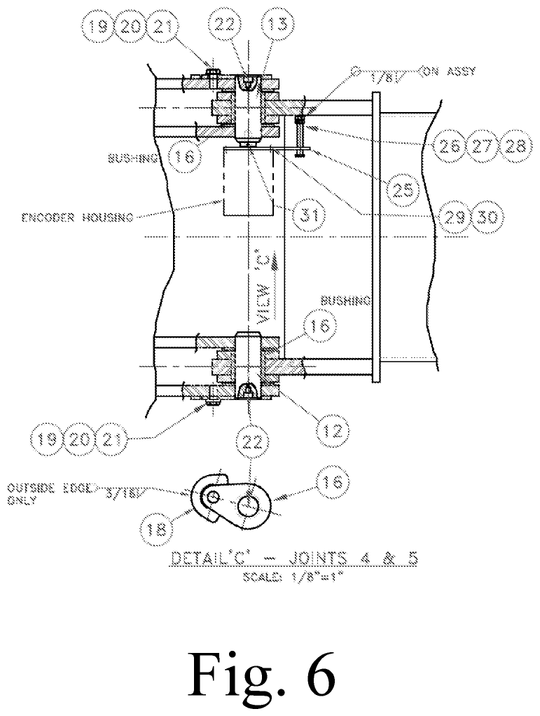

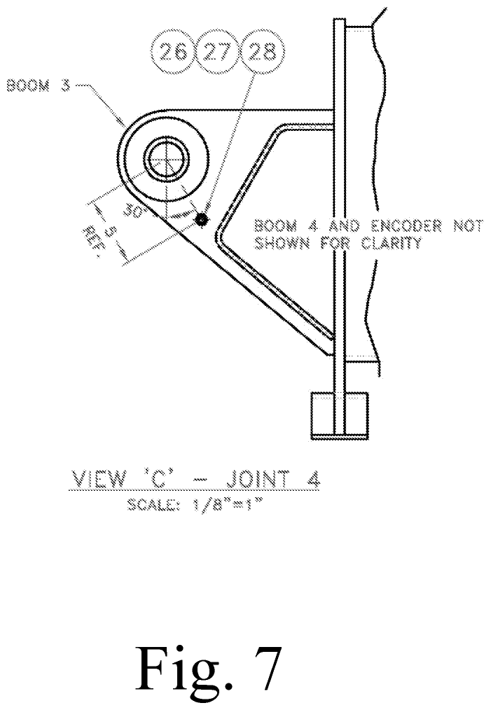

Now referring to FIGS. 6 and 7 illustrating Joint 4, on an opposing end of the third boom 4 a capscrew 26, nut 27, jam nut 28 attaches a fourth boom 5 to the third boom 4. A third cylinder 8 is connected between the third boom 4 and the fourth boom 5 to provide articulation by using a pin 10, bushing 15, pin keeper 18, spacer 19, capscrew 20, flat washer 21, and a grease fitting 22 on each end to secure the third cylinder 8 to the third boom 4 and fourth boom 5.

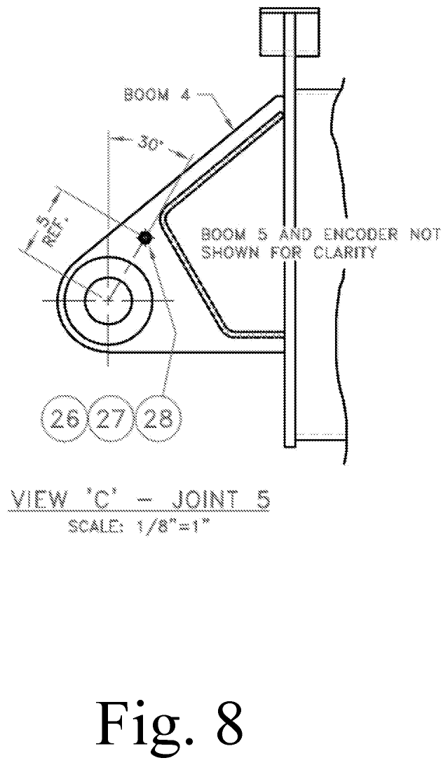

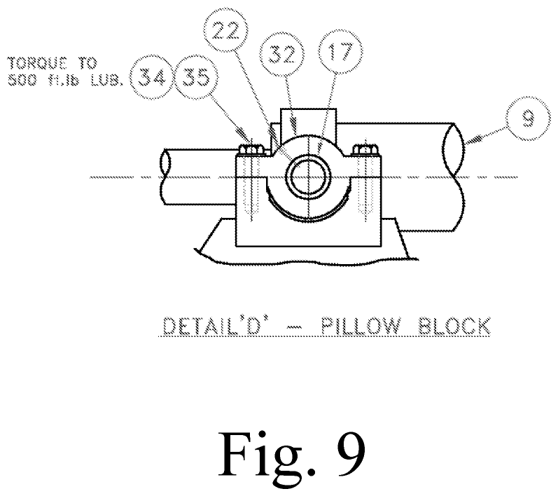

Now referring to FIGS. 6 and 8 illustrating Joint 5, on an opposing end of the fourth boom 5 a capscrew 26, nut 27, jam nut 28 attaches a fifth boom 6 to the fourth boom 5. A fourth cylinder 8 is connected between the fourth boom 5 and the fifth boom 6 to provide articulation by using a pin 10, bushing 15, pin keeper 18, spacer 19, capscrew 20, flat washer 21, and a grease fitting 22 on each end to secure the fourth cylinder 8 to the fourth boom 5 and fifth boom 6.

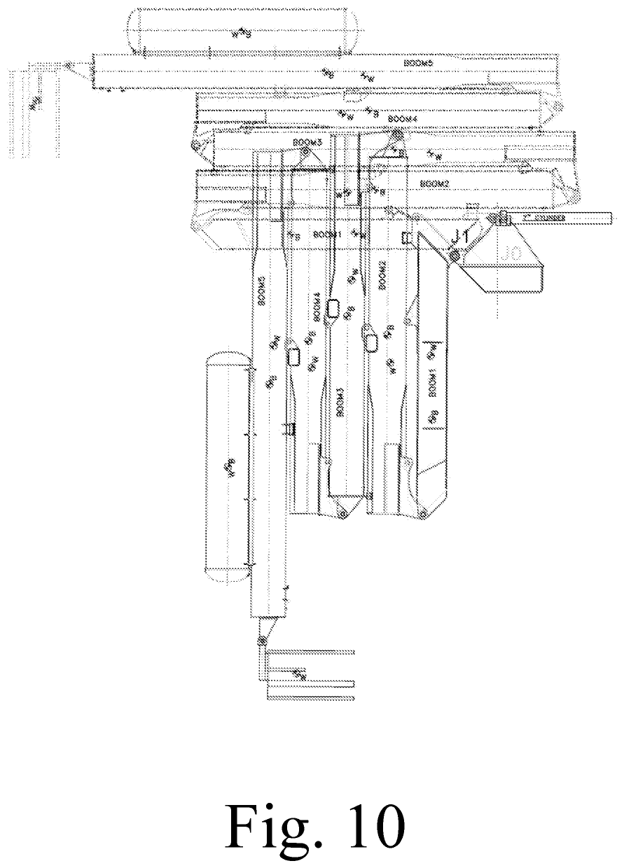

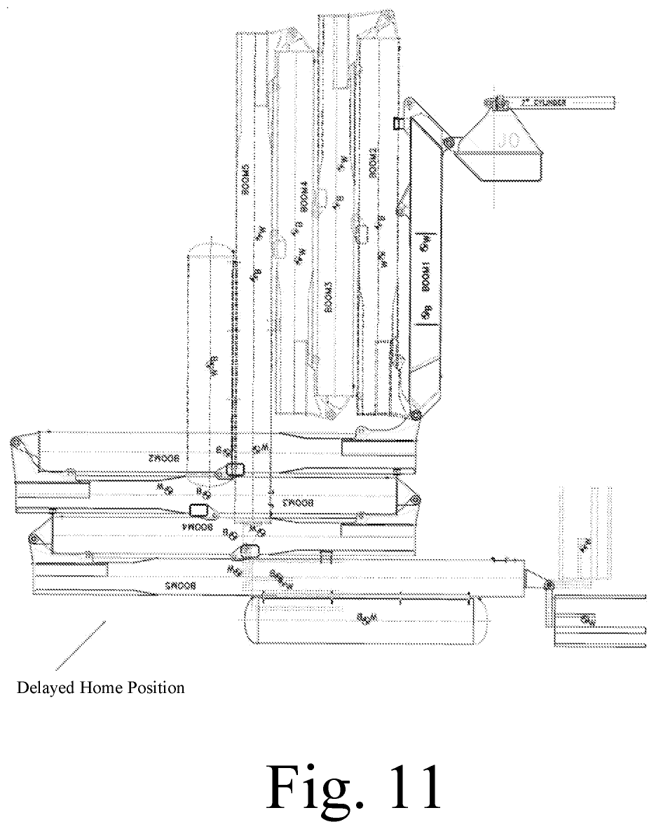

FIGS. 10-11 illustrate the manually controlled deployment procedure and home position of the motion of the ARM. The deployment procedure will always be done in manual mode. Once the robotic arm is in the deployed “home position” the computer control will be activated.

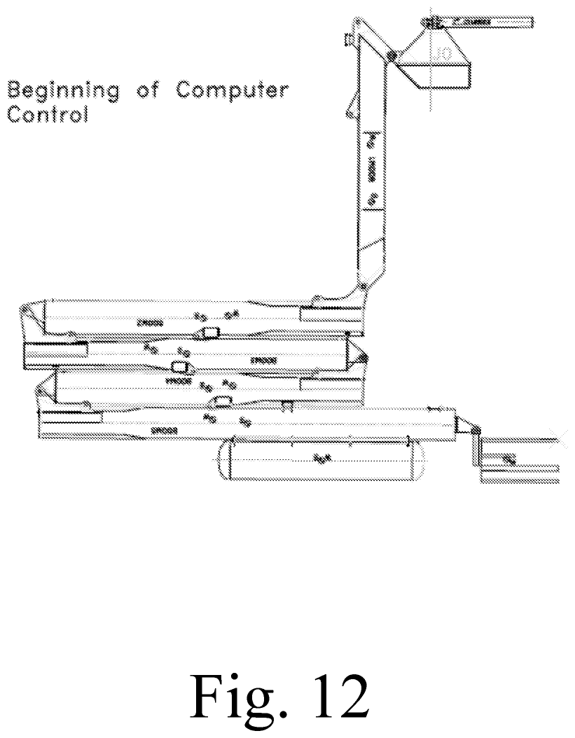

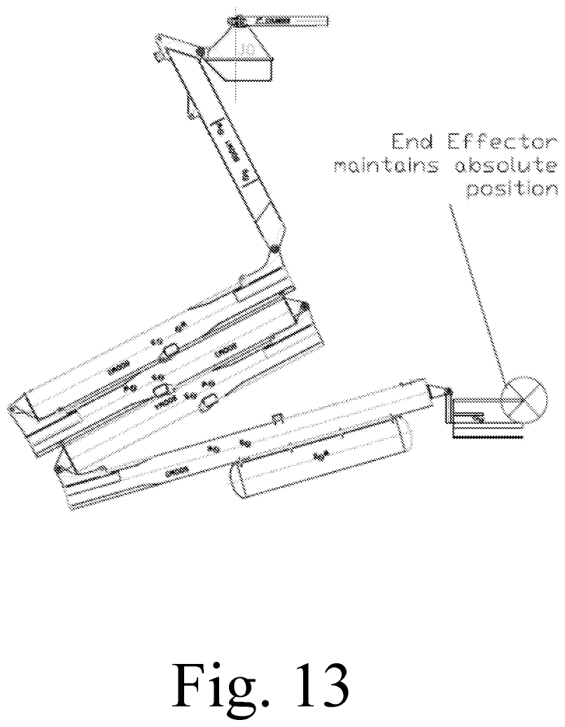

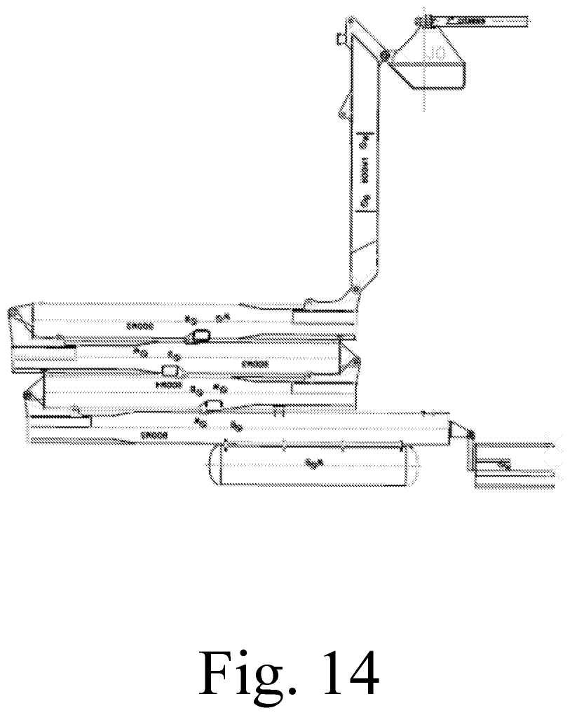

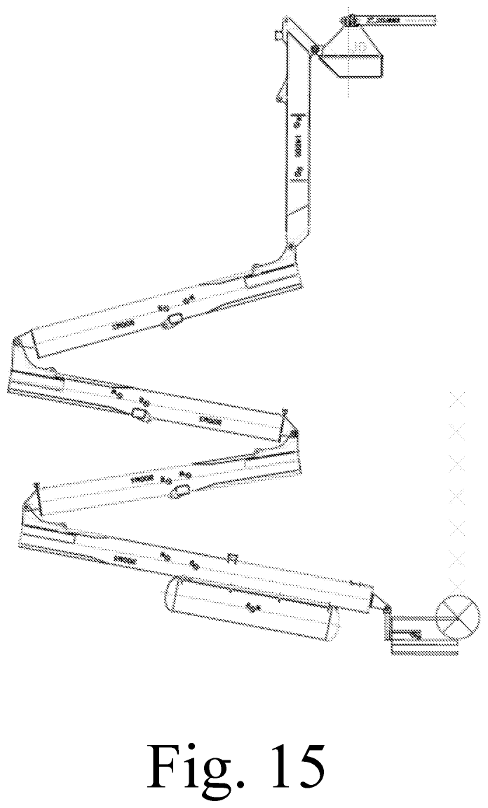

FIGS. 12-15 illustrate the computer controlled motion of the ARM. In FIG. 10, the beginning of the computer controlled articulation is illustrated. An end effector maintains absolute potions for the ARM as the cylinders extend and being to unfold the ARM from its stored position and through intermediate positions until it reaches and extended, operating position. The intermediate positions are calculated on the fly in real time while the operator has the respective switch activated, the system continues to calculate and move to these intermediate positions. The resolution of these intermediate positions needs to be relatively adjustable. It is possible for the operator to have both co-ordinate controls active at the same time, which need to be taken into consideration.

Thus, it is appreciated that the optimum dimensional relationships for the parts of the invention, to include variation in size, materials, shape, form, function, and manner of operation, assembly and use, are deemed readily apparent and obvious to one of ordinary skill in the art, and all equivalent relationships to those illustrated in the drawings and described in the above description are intended to be encompassed by the present invention.

Furthermore, other areas of art may benefit from this method and adjustments to the design are anticipated. Thus, the scope of the invention should be determined by the appended claims and their legal equivalents, rather than by the examples given.

1. An articulating robotic manipulator for underwater wood harvesting, comprising:
a floating barge;
a mechanical articulating arm that folds onto of itself and sits on the floating barge;
at the end of the mechanical articulating arm, there is a cutting and grasping head;
the barge is a horseshoe cape,
the folding arm deploys down the center of the barge and into the water; and
the mechanical articulating arm is controlled by an operator who is placed in a cabin on the barge above.

2. The device of claim 1, wherein the barge contains side thrusters.

3. The device of claim 1, further comprising side scan sonar units providing a visual display of underwater objects.

4. The device of claim 1, wherein
the mechanical articulating arm is 120-feet with a single ballast/tank.

5. The device of claim 1, wherein the mechanical articulating arm drops down and swivels 180-degrees.

6. The device of claim 1, wherein the mechanical articulating arm is further comprised of
an air delivery system enclosed in the arm from the barge to the cutting head; and
the cutting head uses a custom cutting head that can open to 10-feet wide.

7. The device of claim 1, wherein
the barge comprises eight ballasts;
the barge contains side thrusters and uses sonar to improve visibility underwater; and
the barge has the mechanical articulating arm being run on its own Barge-system and is motorized separately.

8. The device of claim 1, further comprising two separate motors:
a first motor to run the hydraulic and produce electrical and
a second motor to propel the barge.

9. The device of claim 1, further comprising
a HITACHI system and 4-cylinder diesel which are all given direction via a LINUX related program or ran manually.

10. The device of claim 1, wherein
the mechanical articulating arm is 60 ft with a two tank system on the far end of the arm.

11. The device of claim 1, wherein the mechanical articulating arm is hinged to the center of a barge deck.

12. The device of claim 1, wherein a water system to bring water down to the cutting area to improve visibility is provided.

13. The device of claim 1, wherein the mechanical articulating arm is further comprised of an air system enclosed in the arm from barge to cutting head.

14. The device of claim 1, wherein other head units that can dredge, grapple, and rake are interchangeably attached to the end of the folding arm.

15. The device of claim 2, wherein the interchangeable utility heads include:
selectively operable claws;
a selectively operable clam shell rake;
a selectively operable overpack;
a selectively operable suction dredge;
a selectively articulatable viewing arm;
a selectively operable core sampling head;
an extraction head;
a selectively operable vibrator head;
a selectively operable grout application head; and
a selectively operable surface cleaning head.

16. An articulating robotic manipulator for underwater wood harvesting, comprising:
a plurality of booms;
a plurality of cylinders;
a plurality of cylinder trunnion;
a plurality of pins;
a plurality of bushings;
a pin keeper;
a plurality of spacers;
a plurality of capscrews;
a plurality of flat washers;
a plurality of grease fittings;
an encoder mounting bracket;
a pluarality of jam nuts;
a plurality of lock washers;
a plurality of set screws;
a pillow block;
a first boom is connected by to a first cylinder on one end by using a pin, bushing, pin keeper, spacer, capscrew, flat washer, and a grease fitting;
on an opposing end of the first boom, the first boom is connected to a second boom using a capscrew, nut, jam nut;
a first cylindered is connect between the first boom and the second boom to provide articulation by using a pin, bushing, pin keeper, spacer, capscrew, flat washer, and a grease fitting on each end to secure the first cylinder to the first boom and second boom;
on an opposing end of the second boom a capscrew, nut, jam nut attaches a third boom to the second boom;
a second cylinder is connected between the second boom and the third boom to provide articulation by using a pin, bushing, pin keeper, spacer, capscrew, flat washer, and a grease fitting on each end to secure the second cylinder to the second boom and third boom;
on an opposing end of the third boom a capscrew, nut, jam nut attaches a fourth boom to the third boom;
a third cylinder is connected between the third boom and the fourth boom to provide articulation by using a pin, bushing, pin keeper, spacer, capscrew, flat washer, and a grease fitting on each end to secure the third cylinder to the third boom and fourth boom; and
on an opposing end of the fourth boom a capscrew, nut, jam nut attaches a fifth boom to the fourth boom;
a fourth cylinder is connected between the fourth boom and the fifth boom to provide articulation by using a pin, bushing, pin keeper, spacer, capscrew, flat washer, and a grease fitting on each end to secure the fourth cylinder to the fourth boom and fifth boom.

17. The device of claim 1, further comprising
a floating barge;
the mechanical articulating arm folds onto of itself and sits on the floating barge;
at the end of the mechanical articulating arm, there is a cutting and grasping head;
the barge is a horseshoe cape,
the folding arm deploys down the center of the barge and into the water; and
the mechanical articulating arm drops down and swivels 180-degrees.

18. The device of claim 17, wherein
the barge contains side thrusters;
side scan sonar units providing a visual display of underwater objects.

19. The device of claim 17, wherein the mechanical articulating arm is further comprised of
an air delivery system enclosed in the arm from the barge to the cutting head; and
the cutting head uses a custom cutting head that can open to 10-feet wide.

20. The device of claim 17, further comprising
two separate motors:
a first motor to run the hydraulic and produce electrical and
a second motor to propel the barge; and
an air system enclosed in the arm from barge to cutting head.
